(19) United States
(12) Patent Application Publication
(10) Pub. No.: US 2004/0096551 A1
(43) Pub. Date: May 20, 2004

(54) Individual portion food delivery system, container and method

(76) Inventor: Gerald J. Tomlinson, Cicero, IL (US)

Correspondence Address: PATENT & TRADEMARK DOCKET CLERK, RYNDAK & SURI, 30 NORTH LASALLE STREET, SUITE 2630, CHICAGO, IL, 60602, US

(21) Appl. No.: 10/714,317

(22) Filed: Nov. 14, 2003

Related U.S. Application Data
(63) Continuation of application No. 09/908,106, filed on Jul. 18, 2001, now abandoned.
Application No. 09/908,106 is a continuation of application No. 09/090,445, filed on Jun. 4, 1998, now abandoned.

(51) Int. Cl. A23B 4/00

(52) U.S. Cl. 426/115

(57) ABSTRACT

An individual portion size food container system and method is provided that is easy for the consumer to handle, facilitates a uniform dispersion of an edible liquid, such as salad dressing, on the food and can be suitable for use in a standard automobile cup holder. The salad container system permits a quantity of an edible liquid, such as salad dressing, to be added thereto and rapidly and easily substantially uniformly dispersed within the quantity of food contained therein prior to consumption.

In addition, an apparatus and method of filling substantially simultaneously a plurality of individual portion size food containers is provided in which a plurality of food containers are contained in a predetermined array.

### CROSS-REFERENCE TO RELATED APPLICATIONS

This application is a continuation of U.S. application Ser. No. 09/908,106, filed Jul. 18, 2001, the disclosure of which is hereby incorporated by reference, which application is a continuation of U.S. application Ser. No. 09/090,445, filed Jun. 4, 1998.

### FIELD OF THE INVENTION

The present invention relates to packaged food portions. More particularly, the invention relates to an individual portion food delivery system, container and method that is particularly suitable for salads and other solid foods that desirably need the addition and mixing of a fluid ingredient, such as a salad dressing, sauce or other liquid, preferably in a uniform manner, with the solid food.

### BACKGROUND

Packaged individual food portions composed of non-particulate pieces of solid food are becoming more popular and can be provided in a wide variety of compositions, containing different types of lettuce, vegetables, fruits, cereals and/or meats, for example, as well as having various types of salad dressings, sauces, gravies, condiments or other liquids added thereto. It is also widely recognized that many of these types of food can be an important part of a person's diet.

Typically, lettuce-based salads, cereals and entrees such as pastas with sauce and other ingredients (such as vegetables and meat, for example) are provided for consumption at a restaurant or for carry out in a salad bowl-type container or in a relatively large flat tray-like container. As used herein, “salad” refers to lettuce-based salads. Such containers are relatively difficult to handle, generally being relatively shallow and occupying a substantial area. Consequently, such containers are not well-suited for easy handling by the consumer, for carry-out and for consumption in motor vehicles, for example.

In addition, because salads are popular food items in quick-service restaurants, it is important to provide individual size portions efficiently so that they can be offered to the consumer for a reasonable cost.

In addition, tray-like food containers and salad containers in particular make it difficult to achieve a uniform dispersion of a desired fluid, such as a salad dressing on salad. Consequently, some of the salad has too much salad dressing while other portions of the salad may not have enough or may not have any dressing at all.

A need exists for individual-size packaged foods, particularly salads (lettuce-based), that are easy for a consumer to handle and lend themselves to relatively convenient consumption in a motor vehicle, for example. A need also exists for an individual portion container, such as a salad container, that permits uniform dispersion on the food of a desired liquid, such as salad dressing, condiment, gravy or pasta sauce contained therein. In addition, a need exists for a method to efficiently provide in large quantity individual portion size foods, particularly salads, packaged in a convenient-to-use container.

### SUMMARY OF THE INVENTION

In accordance with another aspect of the present invention, a food container system and method is provided that is economical and easy to use, and is particularly suited for salads and other types of solid food that desirably need the addition and mixing of a fluid ingredient, such as salad dressings, sauces (such as a cheese, a pasta or a cream sauce, for example), condiments (such as ketchup, mustard, mayonnaise or barbeque sauce, for example) and gravies, for example. Preferably, the food container is of a size for containing an individual or single serving portion of food (i.e., an amount of food intended for consumption by one person at one meal). The individual portion size food container is easy to handle, and can be suitable for use in standard automobile cup holders. In addition, it permits a desired fluid to be uniformly dispersed on or within the food contained within the container, such as salad dressing on a salad or yogurt on fruit and granola, for example.

In accordance with one aspect of the present invention, a method of filling substantially simultaneously with a solid prepared (ready-to-eat) food a plurality of individual portion-sized elongated food containers is provided. Preferably, in one embodiment, the food containers are of an elongated cylindrical shape. Salad is a type of solid food that is particularly suitable for use in accordance with the invention. Generally, the prepared solid food will be non-granular (e.g., not in a powder or in a uniform granular size, such as granular sugar, for example).

The method includes providing in a predetermined array a plurality of unfilled upstanding elongated food containers, positioning a tray having a plurality of openings corresponding to the array of food containers directly over the array of food containers, the openings of the tray adjacent the food containers being no larger than the openings of the corresponding food containers. The tray may be positioned sufficiently above the top of the food containers to permit the containers to be overfilled with the food. Such an arrangement is particularly useful for salads, and similar foods that settle after a period of time. For example, the containers can be overfilled so that after settling, the container is completely filled or filled to a desired degree (usually to a greater degree than if the container had been filled but not overfilled with the food). A quantity of food to be filled in the containers is placed on the surface of the tray and the food is then spread across the tray to cause the food to fall by gravity into the containers. The process of placing the food on the tray and spreading the food across the tray can be continued until the food containers are either filled or a desired amount of food is provided in each container. Optionally, the tray may be provided with an opening free area of suitable size, usually located along a perimeter of the tray, to permit any excess food remaining on the tray after the containers have been filled to a desired level to be moved to the opening free area of the tray for reducing any food spillage when the tray is removed from its position directly over the food containers.

In accordance with another aspect of the present invention, an apparatus is provided for filling substantially simultaneously with a prepared solid food a plurality of individual portion-sized elongated food containers, which in one embodiment have an elongated generally cylindrical shape. The apparatus includes a rack for retaining a plurality of elongated open-topped containers in a substantially upright position in a predetermined array. The apparatus further includes a flat tray having a generally upstanding perimeter wall, the tray having a plurality of openings in an array corresponding to the predetermined array of the rack. Structure is provided for aligning the flat tray openings with the predetermined array of the rack so that an aligned position is obtained which permits filling of the containers contained by the rack through the openings of the tray. Structure is also provided for maintaining the tray in the aligned position relative to the rack. The apparatus in accordance with the present invention allows for a large number of individual portion-sized elongated food containers to be filled rapidly and economically, with a minimum of spillage or other waste. The tray may incorporate a funnel-like structure to facilitate the filling of the food containers through the openings. The funnel structure will generally depend downwardly from each of the tray openings and can have sidewalls that diverge, converge or that are vertical, as the funnel extends downwardly from the tray. A diverging funnel configuration is particularly suited for use with settleable, compressible foods such as lettuce-based salads.

In accordance with another aspect of the apparatus of the present invention, the tray has an opening-free area to permit food to be stored thereon at a distance removed from any of the openings so that food can be placed in that area without falling through any of the openings when the tray is removed from the rack such as after the food containers have been filled to a desired level and the flat tray is removed from its position over the rack. The opening free area preferably will be adjacent a perimeter portion of the tray.

In accordance with another aspect of the present invention, a packaged individual portion salad is provided that includes an elongated container having an open top for containing the individual portion of salad and a removably attachable lid for closing the open top of the container in at least a substantially liquid leak-proof manner. The removable lid can be a snap-on lid, a screw-on lid, a clamp-on lid or some other type of removable and reattachable lid, for example. The lid is positionable to cover the top of the container and to provide a closed container and lid combination that is at least substantially liquid leak-proof. The lid is dimensioned to provide an enclosed volume above the top of the container that is at least about 10%, and more preferably 20% or more, of the volume of the container. In this manner, a minimum “head space” is provided above the container top to readily permit and enhance mixing of the salad and a salad dressing after the dressing has been poured over the salad. Generally, mixing can be effectively accomplished by the consumer manually shaking the container having the salad and dressing contained therein while the lid is in a snap lock relationship over the open end of the container. In accordance with another aspect of the invention, the lid is dome-shaped. Vigorous shaking for a brief period, such as about 15-20 vigorous shakes over a period of about 5-10 seconds will generally be sufficient to obtain suitable dispersion of salad dressings. Usually, salad dressings having a viscosity in the range of from about 500 to 11,000 cps will be preferred for use in accordance with the invention for ease of dispersion in the salad, although salad dressings that have a higher or lower viscosity can be used. Usually, salad dressings such as vinaigrette will be on the lower end and dressings such as a thick ranch or creamy caesar will be on the upper end of the foregoing viscosity range.

In accordance with another aspect of the invention, a method of substantially uniformly dispersing a quantity of a desired fluid, such as a salad dressing, sauce, condiment or other liquid in an individual portion size quantity of solid food, especially salad, is provided. The method includes providing an elongated upstanding food container having an open top that is substantially filled with the solid food (salad, for example) and adding to the food contained in the container a desired quantity of the desired fluid (salad dressing, for example). Thereafter, a lid is attached to the open top of the food container to close the salad container in a substantially liquid leak-proof manner, the lid providing an enclosed volume in addition to the volume of the food container that is at least about 10% of the food container volume. Thereafter, the closed food container is shaken until the fluid (salad dressing) is substantially uniformly dispersed on the food (salad). Generally, the closed food container will be shaken by hand, such as by the ultimate consumer of the product, usually immediately prior to consumption.

### BRIEF DESCRIPTION OF THE DRAWINGS

FIG. 1 illustrates in perspective view a packaged, individual portion size salad in accordance with the invention;

FIG. 2 illustrates in perspective view further preparation of the packaged, individual portion size salad of FIG. 1;

FIG. 3 illustrates a further preparation step for the packaged, individual portion size salad of FIG. 2 with a suitable eating utensil for consuming the salad;

FIG. 4 is a cross-sectional view illustrating the packaged, individual portion size salad along lines 4-4 of FIG. 1;

FIG. 5 illustrates the salad of FIG. 4 after further preparation in accordance with the invention by mixing the salad with a salad dressing;

FIG. 6 illustrates a fragmentary cross-sectional view of an alternative embodiment of a salad container in accordance with the invention;

FIG. 7 illustrates an alternative type of food packaged as an individual size portion in accordance with the invention in a sectional view;

FIG. 8 illustrates in sectional view an alternative embodiment for attachment of the lid to the container;

FIG. 9 illustrates in sectional view an alternative embodiment of an individual size packaged food portion in accordance with the invention;

FIG. 10 illustrates in perspective view an alternative embodiment of an individual size packaged food portion in accordance with the invention;

FIG. 11 illustrates in perspective view an alternative embodiment of an individual size packaged food portion in accordance with the invention;

FIG. 12 illustrates apparatus in accordance with the invention suitable for filling salad containers in accordance with the present invention;

FIG. 13 illustrates an exploded perspective view of the apparatus of FIG. 5;

FIG. 14 illustrates a cross-sectional view of the apparatus of FIG. 5 along lines 7-7 of FIG. 5;

FIG. 15 illustrates use of the apparatus of FIG. 12 after the salad containers have been filled to a desired level; and

FIGS. 16-18 illustrate a fragmentary cross-sectional elevation view of alternate embodiments of the apparatus of FIG. 12.

### DETAILED DESCRIPTION OF THE INVENTION

Referring to the figures generally and in particular to FIG. 1, there is illustrated a packaged, individual portion size salad 10 which is composed of salad 12 contained within salad container 14. Salad container 14 consists of an elongated cylindrically shaped cup-like receptacle 16 and a snap-lock opening-free dome-shaped lid 18, illustrated in a snap-lock position over cup-like receptacle 16, which, in this position, closes salad container 14 such that it is capable of retaining liquids in a leak-proof or substantially leak-proof manner. A substantially liquid leak-proof seal is provided between lid 18 and cup-like receptacle 16.

Cup-like receptacle 16 and lid 18 are preferably constructed of a transparent plastic material, although any material suitable for such items can be used, whether transparent, opaque or semi-transparent.

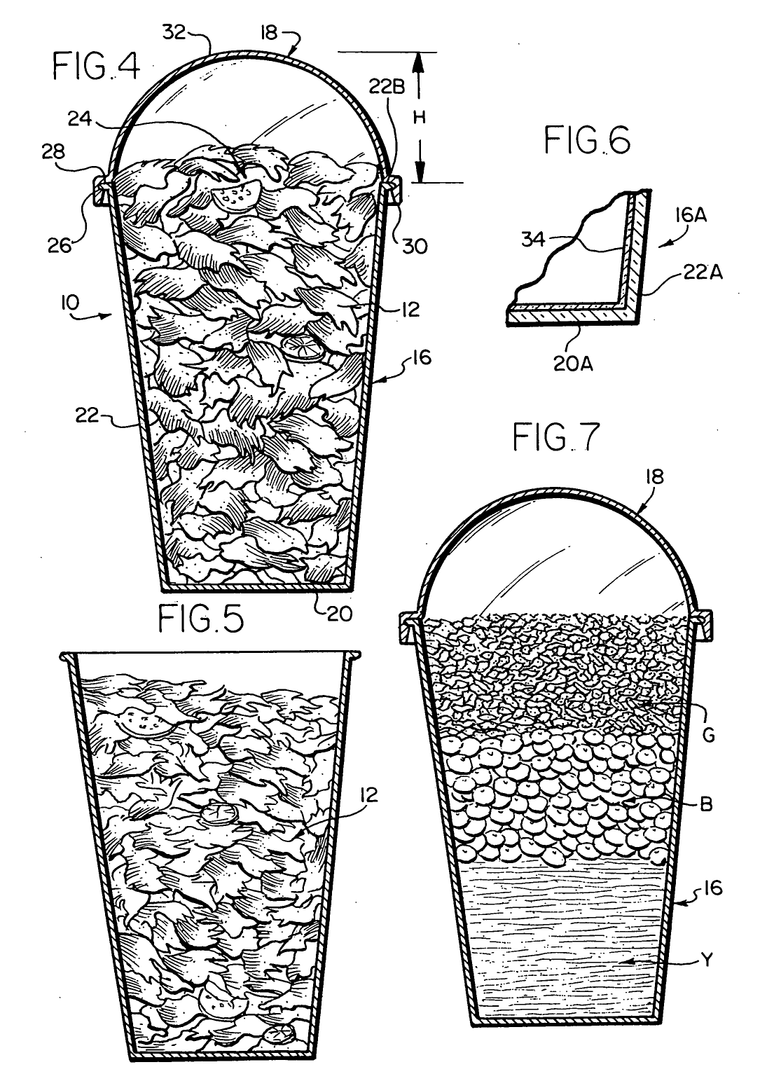

Referring to FIG. 4, there is illustrated in cross-sectional view along lines 4-4 of FIG. 1, salad container 14 in a closed position having salad 12 contained therein. As illustrated, cup-like receptacle 16 has a generally flat bottom 20 and a diverging cylindrical side wall 22 extending upwardly from bottom 20. Receptacle 16 can be of any desired shape, including cylindrical (receptacle 16 of FIG. 1), square (receptacle 16′ of FIG. 11), hexagonal (receptacle 16″ of FIG. 10), for example, or any other desired shape, such as oval, non-square, rectangular or some other shape. Lids 18′, 18″ and 18′″ of FIGS. 11, 10 and 9, respectively, conform to the shape of the container top for proper mating engagement, being square, octagonal and circular, respectively. Each of containers 16′ and 16″ have slightly diverging sidewalls 22′ and 22″ and container 16′″ has a slightly diverging sidewall 22′″. Each of lids 18′, 18″ and 18′″ are secured to respective containers 16′, 16″ and 16′″ by a snap-lock arrangement similar to the snap-lock arrangement of container 16 and lid 18. Bottom 20 could also be slightly concave or convex, as desired.

Preferably, cup-like receptacle 16 is cylindrical and is about 5.7 inches in height, has a diverging cylindrical sidewall with a top outer diameter of about 3.8 inches and a bottom outer diameter of 2.3 inches and a volume of about 21 ounces. Cylindrical side wall 22 terminates at the opening 24 of cup-like receptacle 16. The upper edge 22B of cylindrical side wall 22 has an outwardly extending curved lip 26 which is complementary to circumferential groove 28 located near the bottom of lid 18 that permits lid 18 and cup-like receptacle 16 to be snap-locked together to close salad container 14 in a liquid leak-proof or at least substantially liquid leak-proof manner. Lid 18 has a downwardly and outwardly extending skirt 30 that depends from the portion of lid 18 which forms the lower edge of complementary groove 28. Skirt 30 facilitates removal of lid 18 from cup-like receptacle 16 by providing a lower edge of lid 18 that the consumer can pull upwardly on relative to cup-like receptacle 16 to separate lid 18 from cup-like receptacle 16.

Snap-lock dome-shaped lid 18 has a substantially spherical dome shape. The center 32 of lid 18 is at a distance H above opening 24 of cup-like receptacle 16. In this manner, lid 18 provides an enclosed head space volume V in addition to the volume of cup-like receptacle 16. Generally, volume V is not intended to contain salad 12 or other food, except for a relatively small portion of food that is located above the top edges of receptacle 16, as shown in FIG. 4. Thus, volume V (less any amount of food contained therein) provides a free head space volume to facilitate mixing of salad 12 with a salad dressing, as hereinafter described.

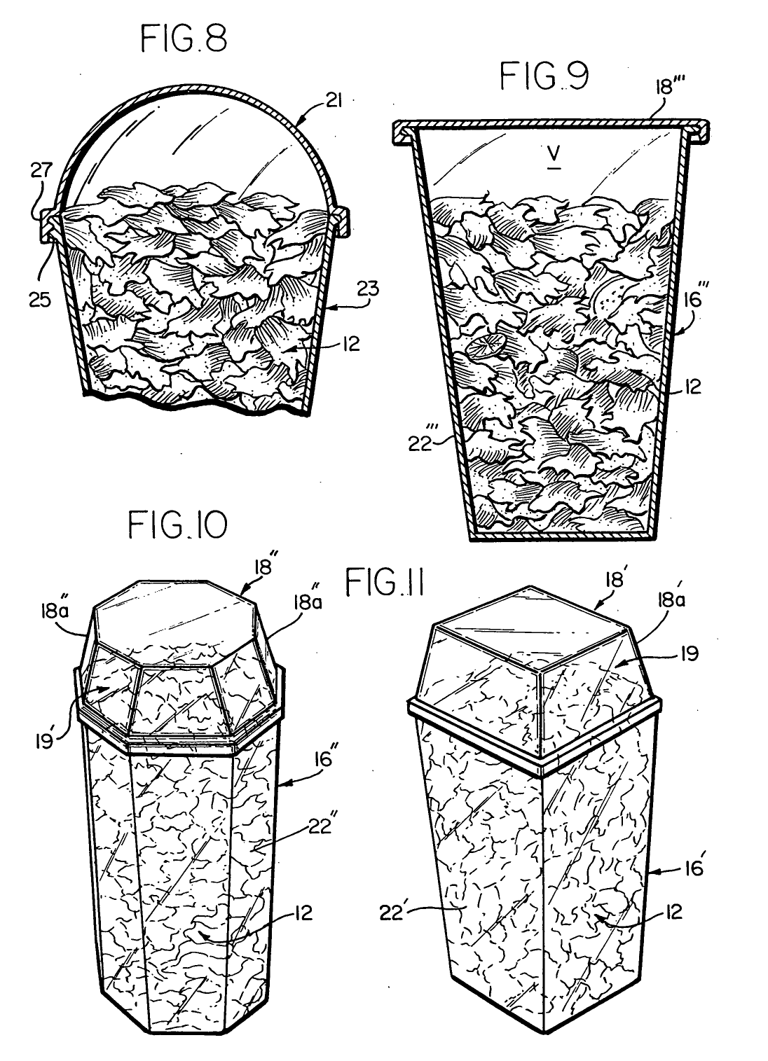

Alternatively, lid 18 can be of a different shape and could, for example, have a flat or generally flat top and straight or generally straight upstanding side walls, as shown lids 18′, 18″ and 18′″ of FIGS. 11, 10 and 9, respectively. The lid may also have ridges on the inner surface to facilitate mixing of salad and salad dressing contained therein such as by shaking the container with the lid snap locked in place, such as ridges 18′a and 18″a of lids 18′ and 18″, for example. Such ridges can facilitate mixing when the container-lid combination is shaken since food striking the ridge or adjacent panels 19 and 19′ will be deflected interiorly towards the longitudinal axis of the container-lid combination. Lids of other shapes can also be employed provided that the lid provides a desired head space volume when placed in position over cup-like receptacle 16 so that mixing of salad 12 and a salad dressing will be facilitated. Generally, free head space volume V should be at least 10% of the volume of cup-like receptacle 16 and, more preferably, about 20% or more of the volume of cup-like receptacle 16. In addition, a lid receptacle arrangement to provide a liquid leak-proof or substantially leak-proof seal can also be used, such as, for example, a threaded screw-on lid or a force-fit lid and receptacle arrangement, for example. FIG. 8 illustrates a screw-on lid 21 and an elongated cylindrical container 23 containing a quantity of salad S. The top of container 23 has thread 25 along its interior top edge and lid 21 has corresponding threads 27 along the interior lower edge thereof to permit lid 21 to be screwed onto container 23.

Referring to FIG. 6, there is illustrated a partial sectional view of a cup-like receptacle 16A which is similar to cup-like receptacle 16 previously described, having a bottom 20A and a diverging cylindrical side wall 22A. In addition, cup-like receptacle 16A has an interior layer or coating 34 which is of a low surface tension material, such as a tetrafluoroethylene fluorocarbon polymer or other suitable low surface tension material that can be used in food contact applications which materials are well known to those skilled in the art. Such a coating reduces the droplet size of liquids that may adhere to the interior surface of cup-like receptacle 16, such as a salad dressing, for example, thereby maximizing the amount of salad dressing that is on the salad. In addition, coating 34 may also be formed on the interior of lid 18 for the same purpose.

Some of the advantages and use of the packaged, individual portion size salad in accordance with the invention are hereinafter described.

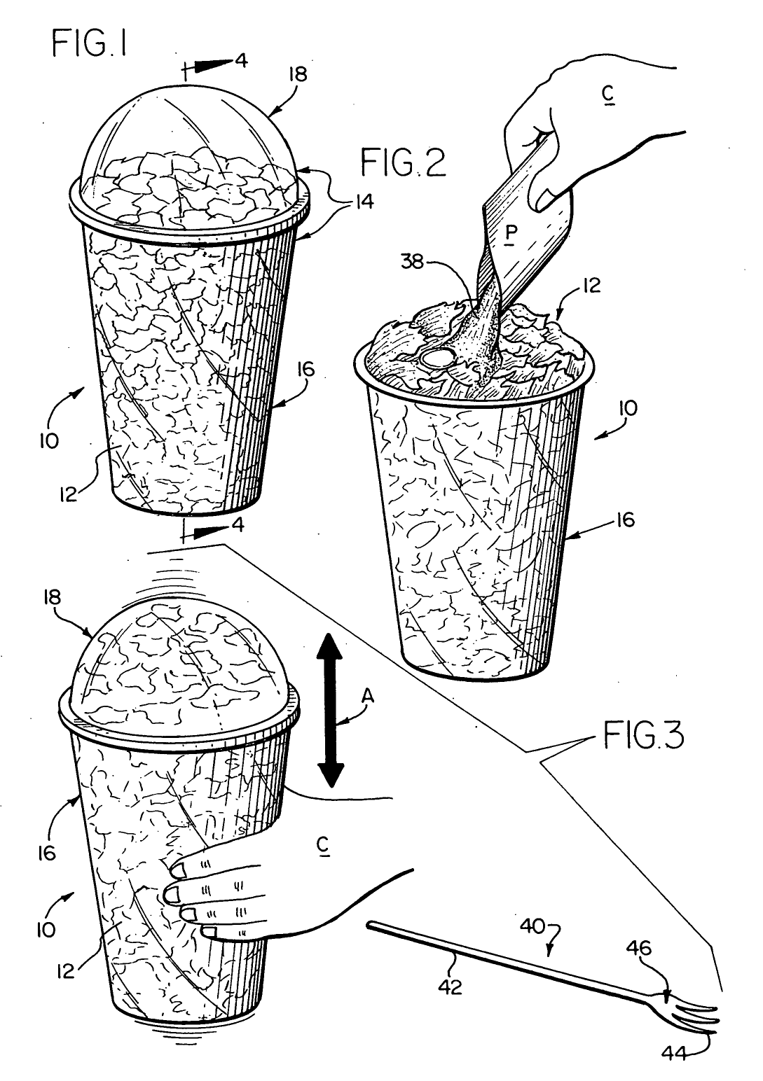

Referring to FIG. 2, there is illustrated a packaged, individual portion size salad 10 with lid 18 removed and a consumer C pouring a packet P of salad dressing 38 onto salad 12, preferably from about 1.5 to about 2.0 fluid ounces of salad dressing for about 21 volume ounces of salad.

Thereafter, after a desired quantity of salad dressing 38 has been poured over salad 12, lid 18 is replaced over opening 24 of cup-like receptacle 16 in a snap-lock position, thereby providing a liquid leak-proof or substantially liquid leak-proof closed container 14. As illustrated in FIG. 3, closed salad container 14 is then shaken up and down in the direction of arrow A by consumer C. One or two fingers may be placed on the lid while shaking to assure that the lid does not become unattached from receptacle 16. By vigorously shaking salad 12 and dressing 38 contained within closed salad container 14, salad dressing 38 becomes uniformly dispersed within salad container 14 on salad 12, as shown in FIG. 5. Generally, vigorous up and down shaking for about 5 to 10 seconds (about 10-15 shakes) is sufficient to uniformly disperse the salad dressing on the salad. As shown in FIG. 5, salad 12 after mixing with salad dressing 38 somewhat compacts the salad so that it occupies a smaller volume than before mixing with the salad dressing. Consequently, it is desirable to initially fill container 14 with salad 12 slightly above the top edge of the container, as shown in FIGS. 2 and 4, for example.

As shown in FIG. 4, free head space volume V facilitates this mixing since salad 12 is allowed to move relative to closed salad container 14 and creates a salad tossing action by salad 12 impacting against the interior surfaces of cup-like receptacle 16 and lid 18.

To facilitate consumption of salad 12 after shaking, a long-handled fork 40 is provided composed of an elongated handle 42 and a plurality of tines 44 that extend from the terminal end 46 of elongated handle 42. Preferably, length of fork 40 will exceed the height of cup-like receptacle 16 so that all of the salad can easily be consumed from therein.

As shown in FIG. 3, cup-like receptacle 16 is configured to permit easy handling by consumer C and permits packaged salad 10 to be easily carried by hand or placed in an automobile cup holder, for example. Consequently, handling of unwieldy relatively large and shallow tray-like salad containers is eliminated and salads can readily be consumed “on-the-go.”

FIG. 9 illustrates an alternate embodiment of the present invention in which a cup-like receptacle 16′″ and a flat lid 18′″ secured to the top of receptacle 16′″ in a snap-lock relationship. The food contained within cup-like receptacle 16′″, which, in this case is salad 12, is filled such that a free head space volume V is provided with flat lid 18′″ being in a snap-lock position enclosing cup-like receptacle 16′″ with a substantially liquid leak-proof seal. When salad dressing is added to salad 12 and lid 18′″ is placed into position to close receptacle 16′″, the container-lid-food combination can be vigorously shaken to effect a mixing of the food contained therein. However, such an arrangement is not as desirable since food settling, particularly with food such as salads, will occur, resulting in a substantially unfilled volume of cup-like receptacle 16′″ before any consumption thereof by the consumer.

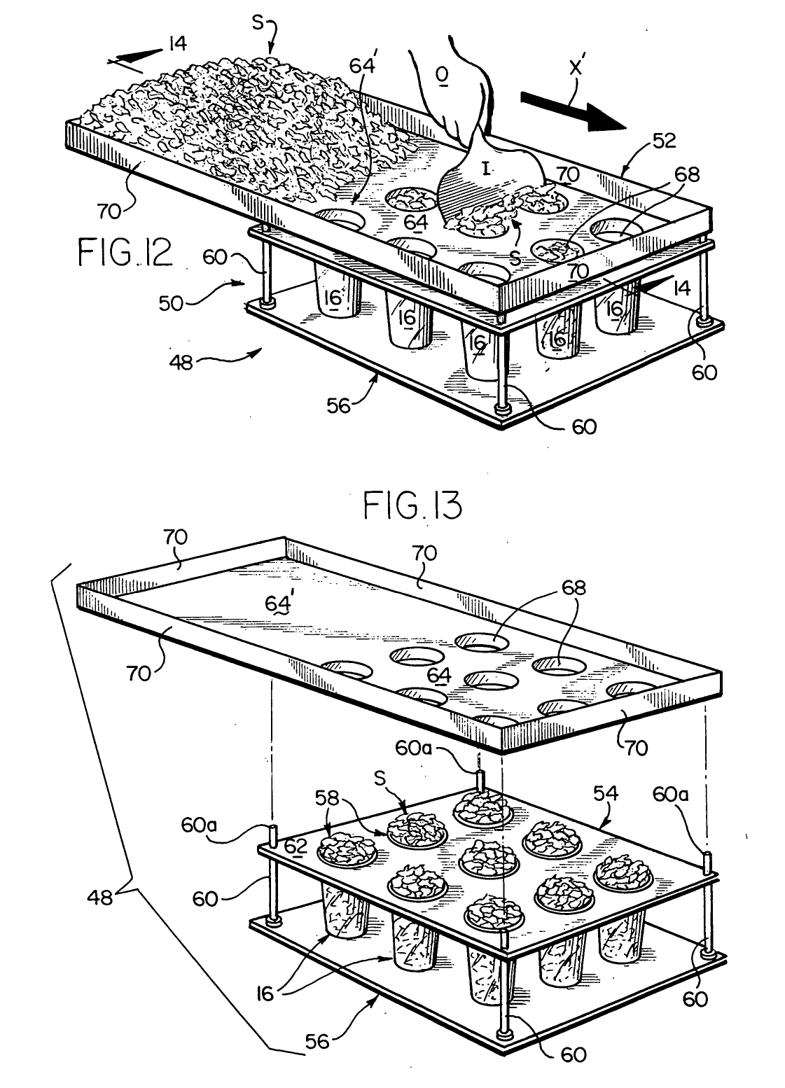

Referring to FIGS. 12-18, there is illustrated a salad filling apparatus 48 in accordance with the invention. Salad filling apparatus 48 permits the substantially simultaneous filling of a plurality of individual portion size salad containers 14 in a rapid and efficient manner. Salad filling apparatus 48 includes a rack 50 for containing a plurality of cup-like receptacles 16 in a predetermined and fixed array which in this case is a 3×3 spaced apart array of cup-like receptacles 16. Salad filling apparatus 48 also includes a flat tray 52 that is complementary to rack 50 and fits thereover as hereinafter described.

As illustrated in FIG. 13, rack 50 is composed of two spaced-apart flat sheets 54 and 56. Flat sheet 54 has a plurality of openings 58 therein that provide the predetermined array for containing cup-like receptacle 16 in a substantially upright position while in the predetermined array. Flat sheets 54 and 56 are separated and held in position relative to each other by four mounting posts 60, one located in each of the four corners of sheets 54 and 56 as illustrated in FIG. 13. Mounting posts 60 have a terminal end portion 60A that extend a slight distance above the top surface 62 of flat sheet 54 to provide a guide for maintaining flat tray 52 in proper relation relative to rack 50 as hereinafter described.

Flat tray 52 is composed of a flat tray portion 64 that includes a plurality of circular openings 68 corresponding to the predetermined array of openings 58 of rack 50. Optionally, a short funnel structure 68A may be provided to facilitate dispensing salad S into cup-like receptacles 16 and extends downwardly from openings 68, as illustrated in FIG. 14. Funnel structure 68A diverges outwardly as it extends downwardly from tray 64 and the interior cylindrical walls 68A′ of funnel structures 68A contacts the upper exterior edge of receptacles 16 to prevent salad from falling outside of receptacles 16. Flat tray portion 64 of flat tray 52 includes a salad retaining area 64′ that is spaced away from circular openings 68 to permit a quantity of salad S to be contained thereon without falling through openings 68. In addition, flat tray 52 desirably has perimeter upstanding side walls 70 to prevent spillage of salad S from tray 52. In addition, the bottom of flat tray 52 has recessed areas 72 that correspond in size and location to terminal ends 60A of mounting posts 60. Recessed areas 72 permit terminal ends 60A to be inserted into recessed areas in either a loose fit, a force fit or a snap lock relationship as desired so that tray 52 is maintained in position over rack 50 during the salad filling operation and yet be easily removable when receptacles 16 have been filled with salads to a desired level.

Other structure may be utilized to maintain tray 52 in a fixed position over rack 50 during the filling operation, as will be recognized by those skilled in the art.

In operation, a quantity of salad S is placed on tray 52 which has been or will be placed in position over rack 50, as illustrated in FIGS. 12-14. A suitable spatula-like tool T can be used by a human operator O to spread the salad S across openings 68 of tray 52, thereby causing salad to fall into containers 14, as shown in FIG. 12 tool T being illustrated as moving along the surface of tray 64 in direction X′. That process can continue until a desired amount of salad S accumulates in cup-like receptacles 16, as illustrated in FIG. 14, arrow X indicating the direction of salad movement into cup-like receptacles 16.

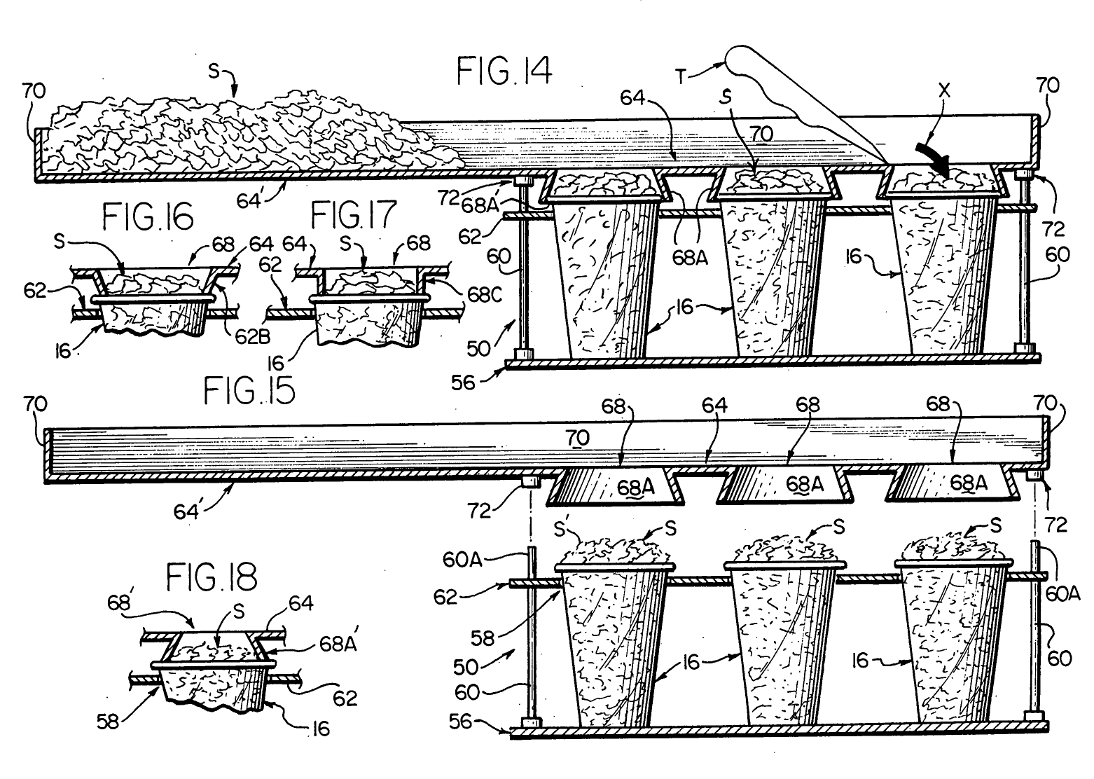

As illustrated in FIG. 15, after cup-like receptacles 16 have been filled to a desired level, tray 52 is removed from its fixed position over rack 50 as illustrated in FIG. 15. Because funnel structure 68A diverges, salad S can form a mound S′ above the top edge of receptacle 16, which mound S′ is not disturbed when tray 52 is removed from rack 50.

Thereafter, cup-like receptacles 16 are removed from rack 50 and lids 18 are applied thereto to provide a packaged, individual portion size salad 10 in a ready-to-serve condition.

Alternative funnel structures can be utilized in accordance with the invention. For example, FIG. 16 illustrates a converging funnel structure 68B extending from tray portion 64. FIG. 17 illustrates a straight funnel structure 68C extending from tray portion 64 and FIG. 18 illustrates a smaller opening 68′ in tray portion 64 and a smaller diameter diverging funnel structure 68A′ extending downwardly from tray portion 64. The lower end of funnel structure 68A′ is of a smaller outer diameter than the inner diameter of receptacle 16 to permit insertion therein to thereby prevent salad from spilling out of receptacle 16.

It is to be understood that numerous types of solid food other than salad are suitable for use in accordance with the invention, including, but not limited to, cereals, pastas, noodles, vegetables, meat and other foods that are substantially solid where it is desired to uniformly apply a sauce, dressing, condiment, gravy or other fluid. For example, one breakfast food would be composed of granola, yogurt, fruit and optionally an amount of juice. More specifically, one breakfast embodiment consists of a 14 oz. elongated cylindrical cup containing (from bottom to top) ½ cup granola, ½ cup yogurt, 2 oz. of chopped strawberries, 1 oz. of blueberries, a layer consisting of banana chips, brown sugar and raisins, 1 oz. of yogurt, an optional fruit garnish and optionally ½ oz. of apple juice. When it is desired to prepare the foregoing breakfast food combination for consumption, the packaged individual portion is shaken sufficiently to relatively uniformly disperse the various foods in the cup enclosed by the lid by shaking and as previously described.

An alternate breakfast food combination is illustrated in FIG. 7, consisting of yogurt (Y), blueberries (B) and granola (G) contained within cup-like receptacle 16 having lid 18 capping receptacle 16 in a snap-lock position.

While the invention has been described with respect to certain embodiments, it will be appreciated that the invention is capable of numerous rearrangements, modifications and changes and such rearrangements, modifications and changes are intended to be within the scope of the appended claims.

1. A method of substantially uniformly applying a quantity of salad dressing in an individual portion size salad contained in an individual portion size container comprising:
providing a vertically elongated upstanding individual portion size cup-like container having a vertical axis and an open top;
substantially filling the cup-like container with salad;
adding to the cup-like container a quantity of salad dressing;
thereafter attaching a container lid to the open top of the cup-like container to close the cup-like container in a substantially liquid leak-proof manner, the lid providing an enclosed volume in addition to the volume of the cup-like container that is between at least about 10% the volume of the cup-like container and substantially less than the volume of the cup-like container; and
shaking the closed cup-like container in a to-and-fro direction substantially along the vertical axis of the cup-like container to cause the salad and salad dressing to periodically contact the container lid and to cause the salad dressing to move relative to the salad until the salad dressing is substantially uniformly applied on the salad.

2. The method of claim 1 wherein the lid is dome-shaped.

3. The method of claim 2 wherein the dome is a hemisphere.

4. The method of claim 1 wherein the container is of a generally cylindrical shape.

5. The method of claim 1 further comprising providing a long-handled fork for consuming the salad contained in the container, the fork having a handle longer than the height of the container.

6. The method of claim 1 wherein said container further comprises a coating of a low surface tension material on the inner surface of the container.

7. The method of claim 1 wherein a portion of the salad present in the container is disposed above the top of the container.

8. The method of claim 1 wherein the volume enclosed by the lid above the top of the container is at least about 20% of the volume of the container.

9. The method of claim 1 wherein said shaking reduces the volume of salad in the container.

10. The method of claim 1 wherein the volume enclosed by the lid above the top of the container is between about 10% to about 20% the volume of the container.

11. The method of claim 1 wherein the container is shaken for about 5 seconds to about 10 seconds.

12. The method of claim 1 wherein the salad is composed of a plurality of salad pieces and said shaking disperses salad dressing onto each salad piece.

13. A method of substantially uniformly dispersing a quantity of an edible liquid in an individual portion of food contained in an individual portion size container comprising:
providing an elongated upstanding food container having an open top that is substantially filled with solid food pieces;
adding to the food contained in the container a quantity of a desired edible liquid;
thereafter attaching a lid to the open top of the food container to close the food container to provide a substantially liquid leak-proof seal between the lid and the container, the lid providing an enclosed volume in addition to the volume of the food container that is between at least about 10% the volume of the food container and less than the volume of the container; and
shaking the closed food container until the edible liquid is substantially uniformly dispersed on the food.

14. The method of claim 13 wherein the lid is dome-shaped.

15. The method of claim 14 wherein the dome is a hemisphere.

16. The method of claim 13 wherein the container is of a generally cylindrical shape.

17. The method of claim 13 further comprising providing a long-handled fork for consuming the food pieces contained in the container, the fork having a handle longer than the height of the container.

18. The method of claim 13 wherein said container further comprises a coating of a low surface tension material on the inner surface of the container.

19. The method of claim 13 wherein a portion of the salad present in the container is disposed above the top of the container.

20. The method of claim 13 wherein the volume enclosed by the lid above the top of the container is at least about 20% of the volume of the container.

21. The method of claim 13 wherein said solid food pieces are selected from the group consisting of lettuce, edible leaves, pasta, noodles, cheese, vegetables, fruit, cereal, meat, chicken, fish and combinations thereof.

22. The method of claim 13 wherein said edible liquid is selected from the group consisting of sauce, salad dressing, condiments and gravy.

23. The method of claim 13 wherein said shaking reduces the volume of food pieces in the container.

24. The method of claim 13 wherein the volume enclosed by the lid above the top of the container is between about 10% to about 20% the volume of the container.

25. The method of claim 13 wherein the container is shaken for about 5 seconds to about 10 seconds.

26. The method of claim 13 wherein said shaking disperses the edible liquid onto each solid food piece.

27. A method of substantially uniformly applying a quantity of salad dressing in an individual portion size salad contained in an individual portion size container comprising:
providing a vertically elongated upstanding individual portion size cup-like container having a vertical axis and an open top;
substantially filling the cup-like container with an individual portion-sized quantity of solid food contained in the container and a packet of liquid food suitable for application to the individual portion of solid food;
adding to the cup-like container a quantity of liquid food from the packet;
thereafter attaching a container lid to the open top of the cup-like container to close the cup-like container in a substantially liquid leak-proof manner, the lid providing an enclosed volume in addition to the volume of the cup-like container that is between at least about 10% to about 20% the volume of the cup-like container; and
shaking the closed cup-like container in a to-and-fro direction substantially along the vertical axis of the cup-like container to cause the solid food and liquid food to periodically contact the container lid and to cause the liquid food to move relative to the solid food until the liquid food is substantially uniformly applied on the individual portion of food.

28. The method of claim 27 further comprising providing a long handled eating utensil for consuming the food contained in the container, the utensil having a handle longer than the height of the container.
